(19) United States
(12) Patent Application Publication
(10) Pub. No.: US 2006/0158572 A1
(43) Pub. Date: Jul. 20, 2006

(54) Electrophoretic display unit

(76) Inventors: Guofu Zhou, Eindhoven (NL); Neculai Ailenei, Heerlen (NL); Masaru Yasui, Kobe (JP); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/563,930

(22) PCT Filed: Jul. 5, 2004
(86) PCT No.: PCT/IB04/51123

§ 371 Date: Jan. 9, 2006

(30) Foreign Application Priority Data
Jul. 11, 2003 (EP) O3102125.6

(51) Int. Cl. G02F 1/13

(52) U.S. Cl. 349/1

(57) ABSTRACT

Electrophoretic display units (1) having fixed frame times are driven relatively unflexibly. By introducing line driving signals having timing parameters, the frame rates can be made variable. With variable frame rates, the optical disturbance from shaking pulses (Sh) is reduced and the number of gray values is increased. The timing parameters comprise delays of starts of line driving signals and/or comprise durations of line driving signals. The lines preferably comprise rows. All possible column driving signals and, per column driving signal or per frame, a row delay parameter defining a row delay time, are stored in a memory coupled to the controller (20). Shaking pulses (Sh) are supplied at minimum row delay time, reset pulses (R) are supplied at maximum row delay time, and driving pulses (Dr) are supplied at flexible row delay time, which corresponds with a product of a predefined timeinterval and a step value defined by a number of bits.

The invention relates to an electrophoretic display unit, to a display device comprising an electrophoretic display unit, to a method for driving an electrophoretic display unit and to a processor program product for driving an electrophoretic display unit.

Examples of display devices of this type are: monitors, laptop computers, personal digital assistants (PDAs), mobile telephones and electronic books, electronic newspapers, and electronic magazines.

A prior art electrophoretic display unit is known from international patent application WO 99/53373. This patent application discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode and of which the gate is coupled to the row electrode. This arrangement of pixels, transistors and row and column electrodes jointly forms an active matrix. A row driver (select driver) supplies a row driving signal or a selection signal for selecting a row of pixels and a column driver (data driver) supplies column driving signals or data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules of about 10 to 50 microns in diameter. Each microcapsule comprises positively charged white particles and negatively charged black particles suspended in a fluid. When a positive field is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative field to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric fields are removed, the display device remains in the acquired state and exhibits a bi-stable character.

To reduce the dependency of the optical response of the electrophoretic display unit on the history of the pixels, preset data signals are supplied before the data-dependent signals are supplied. These preset data signals comprise pulses representing energies which are sufficient to release the electrophoretic particles from a static state at one of the two electrodes, but which are too low to allow the particles to reach the other one of the electrodes. Because of the reduced dependency, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history, which requires a long switching time to overcome this high dependency. The application of the preset data signals increases the momentum of the electrophoretic particles and thus reduces the dependency (and allows a shorter switching time).

Each update of the pixels of the electrophoretic display unit requires, per row, a row driving action for supplying the selection signal to the row for selecting (driving) this row, and a column driving action for supplying pulses, like for example pulses of the preset data signals and pulses of the data-dependent signals, to the pixels. The time-interval required for driving all pixels of all rows once (by driving each row one after the other and by driving all columns simultaneously once per row) is called a frame period.

So, during a first set of frames, the pulses of the preset data signals are supplied to the pixels, with each pulse having a duration of one frame period. The first pulse for example has a positive amplitude, the second one a negative amplitude, and the third one a positive amplitude etc. As long as the duration of these alternating pulses is relatively short, the pulses do not change the gray value displayed by the pixel.

During a second set of frames comprising one or more frame periods, one or more pulses of the data-dependent signals are supplied. The data-dependent signals have a duration of zero, one, two to for example fifteen frame periods. Thereby, a data-dependent signal having a duration of zero frame periods for example corresponds with the pixel displaying full black (in case the pixel already displayed full black; in case of displaying a certain gray value, this gray value remains unchanged when being driven with a pulse having a duration of zero frame periods, in other words when being driven with a pulse having a zero amplitude). A data-dependent signal having a duration of fifteen frame periods comprises fifteen subsequent pulses and for example corresponds to the pixel displaying full white, and a data-dependent signal having a duration of one to fourteen frame periods comprises one to fourteen subsequent pulses and for example corresponds to the pixel displaying one of a limited number of gray values between full black and full white.

As each frame has the same fixed duration, the driving of the electrophoretic display unit is highly unflexible. The pulses of the preset data signals are of a fixed duration and cannot be made shorter for reducing possible optical disturbance resulting from particle disturbance during the first set of frames. The number of gray values is limited, and cannot be increased, with the difference between two subsequent gray values being rather large.

The known electrophoretic display unit is disadvantageous, inter alia, due to the driving of the electrophoretic display unit being relatively unflexible.

It is an object of the invention, inter alia, of providing an electrophoretic display unit with a relatively flexible driving. The invention is defined by the independent claims. The dependent claims define advantageous embodiments.

Furthers objects of the invention are, inter alia, providing a display device comprising an electrophoretic display unit with a relatively flexible driving, and providing a method for driving an electrophoretic display unit and a processor program product for driving an electrophoretic display unit, for use in (combination with) an electrophoretic display unit with a relatively flexible driving.

The electrophoretic display unit according to the invention comprises
an electrophoretic display panel comprising lines with pixels;
a line driver for driving the lines; and
a controller for supplying a line driving signal having a timing parameter to the line driver, the controller being adapted to vary the timing parameter for varying a frame rate of the electrophoretic display unit.

By using line driving signals having timing parameters, the frame rate of the electrophoretic display-unit can be varied by varying these timing parameters. This results in a more flexible driving.

In an embodiment the timing parameter is formed by a delay of a start of the line driving signal. By delaying the start of driving at least one line the duration of frame during which the driving of one or more lines is delayed is no longer fixed, but depends upon the line delay time used. A line may correspond to a column or a row. Generally, the frame delay time is the sum of all line delay times. Usually, but not exclusively, the lines in a frame all have each the same line delay time, with the frame delay time in that case being the product of this line delay time and the number of lines. The line delay time may be varied per one or more frames, resulting in a variable frame delay time and a variable frame rate. As a result, the driving has become more flexible, as illustrated below.

The prior art frame rate is for example 50 Hz and is, for example, increased to 130 Hz, to be able to introduce line delay times. At this frame rate, the minimum frame time is 7.7 ms. By introducing a frame delay between 0 and 45.9 ms., a maximum frame time is 53.6 ms. When supplying the pulses of the preset data signals, the minimum frame delay (in other words no delay at all) is introduced. An optical disturbance occurs in this case at a frame rate of 130 Hz. Such a disturbance is less visible compared to an optical disturbance at a frame rate of 50 Hz. When supplying the pulses of the data-dependent signals, during one or more of the frames, a frame delay between 0 and 45.9 ms. is introduced. As a result, the gray value to be displayed can be defined more accurately. Thereby, for example one frame has a first frame delay time, and an other frame has a second frame delay time different from the first frame delay time. Then, for example one pixel is driven during the one frame by supplying a pulse with an amplitude of 15 Volt to this one pixel during this one frame, and is driven during the other frame by supplying a pulse with an amplitude of 0 Volt to this one pixel during this other frame. This results in a change of the display of the gray value proportional to the one frame period. An other pixel is driven during the one frame by supplying a pulse with an amplitude of 0 Volt to this other pixel during this one frame, and is driven during the other frame by supplying a pulse with an amplitude of 15 Volt to this other pixel during this other frame. This results is a change of the gray value proportional to the other frame period. In this way, different pixels may display different gray levels.

In another embodiment the timing parameter is formed by a duration of a line driving signal of a line. This embodiment may be combined with the earlier mentioned embodiment.

If the timing parameter corresponds to a product of a predefined time-interval and a step value defined by a number of bits, it is easy to realise the timing parameter.

If the lines are rows, the invention is particularly advantageous due to the one or more row drivers, when driving a row of pixels, bringing all transistors coupled to this row of pixels in a conducting state, after which the one or more column drivers can supply the data to the row of pixels via the columns and via the conducting transistors. As the one or more row drivers control all transistors of this row, a row delay time can be introduced easily. Row drivers are also known as selection drivers.

An embodiment of an electrophoretic display unit according to the invention is defined by claim 6. By storing in a memory coupled to or incorporated in the controller, for example, all possible column driving signals (with each column driving signal comprising pulses of the preset data signals followed by one or more pulses of the data-dependent signals) information about a timing parameter like, for example, a row delay parameter defining the row delay time as well as per column driving signal and/or per frame etc., the necessary row delay is automatically generated when selecting one of the column driving signals to be supplied to a pixel. Other pixels in the same row possibly requiring another row delay time are, during this frame, driven with a pulse with an amplitude of 0 Volt which results in an unchanged display of the previous gray value for these other pixels. Column driving signals are also known as data signals.

Shaking pulses for example correspond with the pulses of the preset data signals discussed before. The driving pulses for example correspond with the pulses of the data-dependent signals discussed before. Reset pulses precede the driving pulses to further improve the optical response of the electrophoretic display unit, by defining a fixed starting point (fixed black or fixed white) for the driving pulses. Alternatively, reset pulses precede the driving pulses to further improve the optical response of the electrophoretic display unit, by defining a flexible starting point (black or white, to be selected in dependence of and closest to the gray value to be defined by the following driving pulses) for the driving pulses. The first row delay time is a fixed row delay time, with the first row delay time being shorter than the second row delay time, because shaking pulses usually require frames to be as short as possible and reset pulses usually require frames for example to be as long as possible. The third row delay time is a flexible row delay time, because driving pulses usually require frames to be flexible for increasing the possible number of gray values to be displayed. The second row delay time may be fixed or flexible.

The display device may be an electronic book, while the storage medium for storing information may be a memory stick, integrated circuit, a memory or other storage device for storing, for example, the content of a book to be displayed on the display unit.

Embodiments of a method according to the invention and of a processor program product according to the invention correspond with the embodiments of an electrophoretic display unit according to the invention.

The invention is based upon an insight, inter alia, that fixed prior art frame times keep the driving unflexible, and is based upon a basic idea, inter alia, that frame times can be made variable by introducing line driving signals having timing parameters.

The invention solves the problem, inter alia, of providing an electrophoretic display unit with a relatively flexible driving, and is advantageous, inter alia, in that possible optical disturbance from the pulses of the preset data signals is reduced and in that the number of possible gray values is increased.

These and other aspects of the invention will be apparent from and elucidated with reference to the embodiments(s) described hereinafter.

In the drawings:

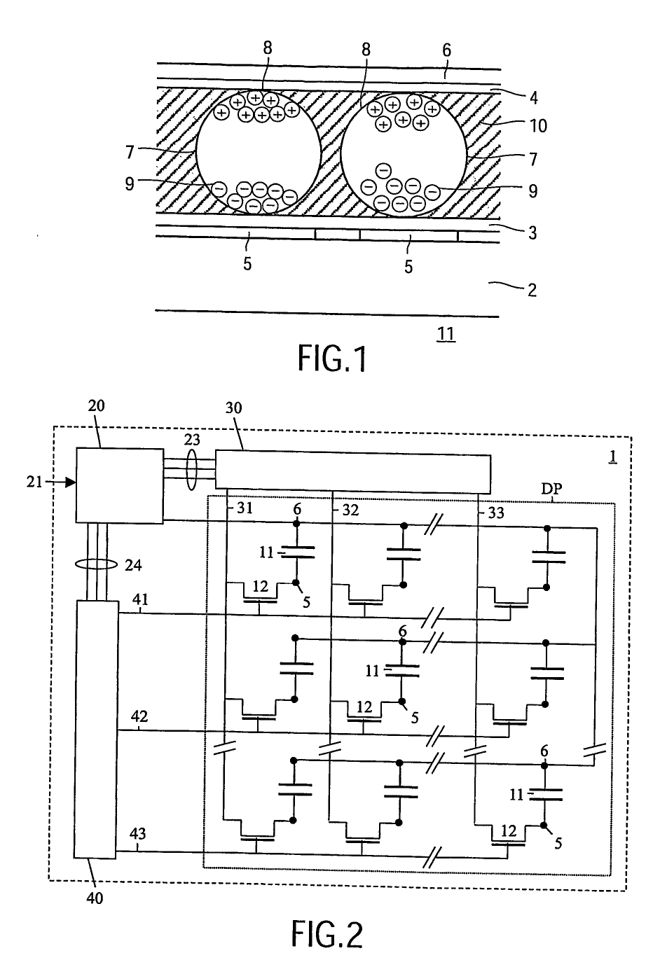

FIG. 1 shows (in cross-section) a pixel;

FIG. 2 shows diagrammatically an electrophoretic display unit;

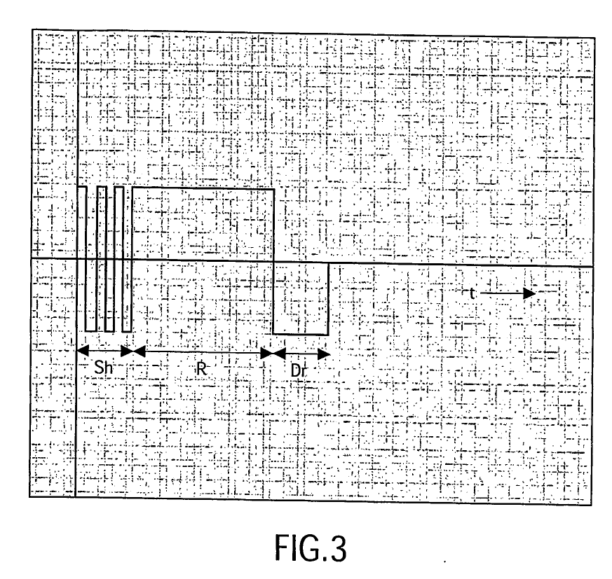

FIG. 3 shows a waveform for driving an electrophoretic display unit; and

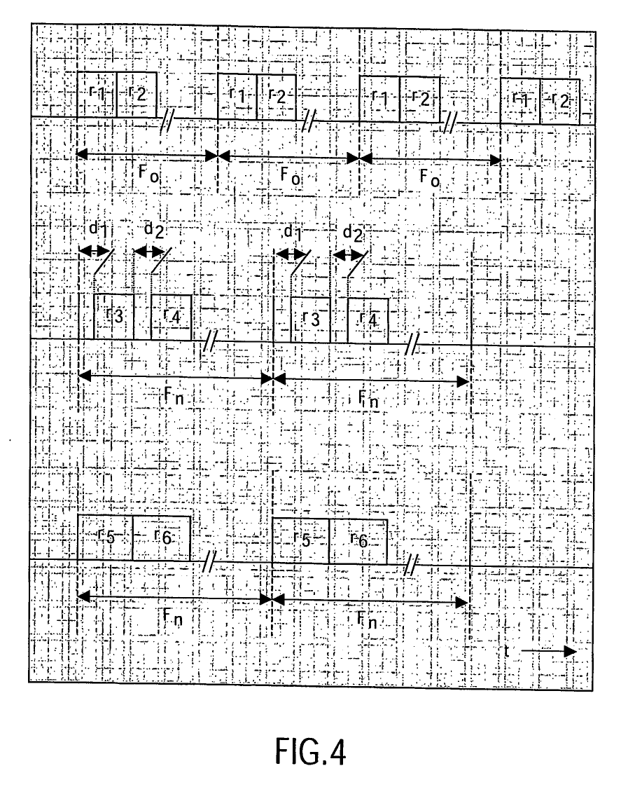

FIG. 4 shows old frames having fixed row driving signals and new frames having flexible row driving signals.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive field is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative field to the pixel electrode 5, the black particles 9 move to the side of the microcapsule 7 directed to the common electrode 6, and the pixel appears dark to a viewer (not shown). When the electric field is removed, the particles 8,9 remain in the acquired state and the display exhibits a bi-stable character and consumes substantially no power.

The electrophoretic display unit 1 shown in FIG. 2 comprises a display panel DP comprising a matrix of pixels 11 at the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises a row driver 40 coupled to the row electrodes 41,42,43 and a column driver 30 coupled to the column electrodes 31,32,33 and comprises an active switching element 12 for each pixel 11. The electrophoretic display unit 1 is driven by these active switching elements 12 (in this example (thin-film) transistors). The row driver 40 consecutively selects the row electrodes 41,42,43, while the column driver 30 provides data signals to the column electrode 31,32,33. Preferably, a controller 20 first processes incoming data arriving via input 21 and then generates the data signals. Mutual synchronisation between the column driver 30 and the row driver 40 takes place via drive lines 23 and 24. Selection signals from the row driver 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to column driver 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking pulses forming the preset pulses, with the data-dependent signals comprising one or more reset pulses and one or more driving pulses. These shaking pulses comprise pulses representing energy which is sufficient to release the electrophoretic particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels. So, the shaking pulses reduce the dependency of the optical response of the electrophoretic display unit on the history of the pixels. The reset pulse precedes the driving pulse to further improve the optical response, by defining a flexible starting point for the driving pulse. This starting point may be a black or white level, to be selected in dependence on and closest to the gray value defined by the following driving pulse. Alternatively, the reset pulse may form part of the data-independent signals and may precede the driving pulse to further improve the optical response of the electrophoretic display unit, by defining a fixed starting point for the driving pulse. This starting point may be a fixed black or fixed white level.

In FIG. 3, a waveform representing voltages across a pixel 11 as a function of time t is shown for driving an electrophoretic display unit 1. This waveform is generated using the data signals supplied via the column driver 30. The waveform comprises shaking pulses Sh, followed by a combination of reset pulses R and a combination of driving pulses Dr. For example for an electrophoretic display unit with four gray levels, sixteen different waveforms are stored in a memory, like, for example, a look-up table memory etc. forming part of and/or coupled to controller 20. In response to data received via input 21, controller 20 selects a waveform for one or more pixels 11, and supplies the corresponding selection signals and data signals via the corresponding drivers 30,40 to the corresponding transistors 12 and the corresponding one or more pixels 11.

A frame period corresponds to a time-interval used for driving all pixels 11 in the electrophoretic display unit 1 once, by driving each row one after the other and by driving all columns once per row. During a data-independent (part of a) frame period, the data-independent signals are supplied to pixels 11, and during a data-dependent (part of a) frame period, the data-dependent signals are supplied to pixels 11. Therefore, in FIG. 3, each pulse, shown as a specific voltage level between two subsequent transitions, represents a separate frame period.

During a first set of frames, the shaking pulses Sh are supplied to the pixels 11, with each shaking pulse having a duration of one frame period. The first shaking pulse for example has a positive amplitude, the second one a negative amplitude, and the third one a positive amplitude etc. These shaking pulses with alternating amplitudes do not change the gray value displayed by the pixel 11, as long as the frame period is relatively short.

During a second set of frames comprising one or more frames periods, a combination of reset pulses R is supplied, further to be discussed below. During a third set of frames comprising one or more frames periods, a combination of driving pulses Dr is supplied, with the combination of driving pulses Dr either having a duration of zero frame periods and in fact being a pulse having a zero amplitude or having a duration of one, two to for example fifteen frame periods. Thereby, a driving pulse Dr having a duration of zero frame periods for example corresponds to the pixel 11 displaying full black (in case the pixel 11 already displayed full black; in case of displaying a certain gray value, this gray value remains unchanged when being driven with a driving pulse having a duration of zero frame periods, in other words when being driven with a pulse having a zero amplitude). The combination of driving pulses Dr having a duration of fifteen frame periods comprises fifteen subsequent pulses and for example corresponds with the pixel 11 displaying full white, and the combination of driving pulses Dr having a duration of one to fourteen frame periods comprises one to fourteen subsequent pulses and, for example, corresponds with the pixel 11 displaying one of a limited number of gray values between full black and full white.

The reset pulses R precede the driving pulses Dr to further improve the optical response of the electrophoretic display unit 1, by defining a fixed starting point (fixed black or fixed white) for the driving pulses Dr. Alternatively, reset pulses R precede the driving pulses Dr to further improve the optical response of the electrophoretic display unit, by defining a flexible starting point (black or white, to be selected in dependence of and closest to the gray value to be defined by the following driving pulses) for the driving pulses Dr.

As all frames have the same fixed duration, the driving of the prior art electrophoretic display unit 1 is highly unflexible. The shaking pulses Sh are of a fixed duration and cannot be made shorter for reducing possible optical disturbance resulting from the particle disturbance during the first set of frames. The number of gray values is limited, and cannot be increased, with the difference between two subsequent gray values being rather large.

By, according to the invention, introducing line driving signals having timing parameters, the controller 20 can vary a frame rate of the electrophoretic display unit 1 through varying one or more timing parameters. A timing parameter is for example formed by a delay of a start of a line driving signal like a row driving signal. A delay of the supply of a row driving signal results in the duration of a frame period no longer being fixed but being dependent on the amount of row delay time used for delaying the row driving signal of the respective rows. The resulting frame period increase is the sum of all row delay times. Usually, but not exclusively, each one of the rows in a frame has the same row delay time, resulting in a frame period increase being the product of this row delay time and the number of rows. The row delay time may be varied per frame, resulting in a variable frame period increase and in a variable frame rate. Such a variable frame rate allows a more flexible driving, as illustrated below.

The prior art frame rate is for example 50 Hz and is now increased to 130 Hz. At this frame rate, the minimum frame period is 7.7 msec. By introducing a frame period increase between 0 and 45.9 msec., a maximum frame period is 53.6 msec. When supplying the shaking pulses Sh, the minimum frame period (in other words no delay at all) is introduced. An optical disturbance at a frame rate of 130 Hz is less visible than an optical disturbance at a frame rate of 50 Hz. The gray value to be displayed via a pixel 11 is realised by supplying one or more driving pulses Dr during one or more frame periods to this pixel 11. When supplying the driving pulses Dr, during one or more of the frames periods, a frame period increase between 0 and 45.9 msec. is introduced. As a result, the one or more driving pulses Dr can be defined more accurately, and the gray value to be displayed is defined more accurately. Thereby, for example, one frame has a first frame period and an other frame has a second frame period different from the first frame period. For example, one pixel 11 is driven during the one frame by, during this one frame, supplying a pulse with an amplitude of 15 Volt to this one pixel 11. This one pixel 11 is driven during the other frame by, during this other frame, supplying a pulse with an amplitude of 0 Volt to this one pixel 11, which results in an unchanged display of the previous gray value. An other pixel 11 is driven during the one frame by, during this one frame, supplying a pulse with an amplitude of 0 Volt to this other pixel 11, which results in an unchanged display of the previous gray value. This other pixel 11 is driven during the other frame by, during this other frame, supplying a pulse with an amplitude of 15 Volt to this other pixel 11. Thus, more gray levels with higher accuracy can be displayed by pixels 11.

FIG. 4 shows (upper graph) old frames Fₒ having fixed row driving signals and (middle and lower graph) new frames Fₙ having flexible row driving signals. In the upper graph, for the sake of clarity, only two old (undelayed) row driving signals r₁,r₂ are shown per old frame Fₒ. In the middle graph, for the sake of clarity, only two new (delayed) row driving signals r₃,r₄ are shown per new frame Fₙ. Row driving signal r₃ has a row delay d₁, and row driving signal r₄ has a row delay d₂. In other words, delay d₁ corresponds with the delay of the start of row driving signal r₃. Delay d₂ corresponds with the delay of the start of row driving signal r₄. In the lower graph, for the sake of clarity, only two new row driving signals r₅,r₆ are shown per new frame Fₙ. Row driving signals r₅,r₆ each have a longer duration than row driving signal r₃,r₄, such that, according to this example, but not exclusively, the duration of one of the row driving signals r₅; r₆ is equal to the sum of the duration of one of the row driving signals r₃;r₄ and its row delay d₁;d₂. This all results in the new frame Fₙ being of a longer duration than the old frame Fₒ, with this duration being dependent on the sum of the row delay times used for driving all rows and/or on the duration of all row driving signals for driving all rows. By varying the row delay time per row and/or the duration of a row driving signal, the frame rate has become flexible. Of course, the creation of flexible frame rates through flexible durations of row driving signals can be realised in a simple way by varying a clock frequency. Alternatively, the end of a row driving signal can be delayed for realising a flexible duration.

A first row delay parameter defines a first row delay time for the shaking pulses Sh; a second row delay parameter defines a second row delay time for the reset pulses R; and a third row delay parameter defines a third row delay time for the driving pulses Dr. Usually, the first and second row delay times are fixed row delay times, with the first row delay time being shorter than the second row delay time, because shaking pulses Sh require frames to be as short as possible and reset pulses R require frames, for example, to be as long as possible. The third row delay time is a flexible row delay time, because driving pulses Dr require frames to be flexible for increasing the possible number of gray values to be displayed. Alternatively, the second row delay time may be a flexible row delay time.

A memory (not shown) coupled to or incorporated in the controller 20 is used for storing information to be displayed and/or for storing all possible column driving signals. Each column driving signal, for example, comprises shaking pulses Sh followed by one or more reset pulses R and one or more driving pulses Dr. The memory is also used for storing information about the timing parameters, like the row delay times and/or the durations. The necessary timing parameter is automatically generated when selecting one of the column driving signals to be supplied to a pixel 11. Other pixels 11 in the same row possibly requiring another frame period (for creating another gray value) are, during this frame, driven with a pulse with an amplitude of 0 Volt which results in an unchanged display of the previous gray value for these other pixels 11.

A row delay time, for example, corresponds with a product of a predefined time-interval of for example 0.30 μsec. and a step value n defined by a number of bits like for example 8 bits (256 steps). Then the row delay time can be defined by a row delay parameter in the form of the step value n (0≦n≦255). After having read out the column driving signal and the corresponding row delay parameter in the form of the 8 bits from the memory, the controller 20 multiplies the step value n with the predefined time-interval, for generating the row delay time. A duration of a row driving signal may also correspond with such a product.

At a frame rate of, for example, 130 Hz, in an experiment a row time of 12.78 μsec. has been obtained. At 600 rows, with a processing time for example being 54,3 μsec. (for performing the before mentioned processing), a minimum frame period becomes 54.3+12.78*600=7722 μsec.≈7.7 msec. By introducing the row delay time of n*0.30 μsec., the frame period becomes 7.7+0.18*n msec. A maximum frame period then is 7.7+0.18*255 msec.=53.6 msec.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display unit (1) comprising:
an electrophoretic display panel (DP) comprising lines with pixels (11);
a line driver (40) for driving the lines; and
a controller (20) for supplying a line driving signal having a timing parameter to the line driver (40), the controller (20) being adapted to vary the timing parameter for varying a frame rate of the electrophoretic display unit (1).

2. An electrophoretic display unit (1) as claimed in claim 1, wherein the timing parameter is formed by a delay of a start of the line driving signal.

3. An electrophoretic display unit (1) as claimed in claim 1, wherein the timing parameter is formed by a duration of a line driving signal of a line.

4. An electrophoretic display unit (1) as claimed in claim 1, wherein the timing parameter corresponds with a product of a predefined time-interval and a step value defined by a number of bits.

5. An electrophoretic display unit (1) as claimed in claim 1, wherein a line corresponds with a row.

6. An electrophoretic display unit (1) as claimed in claim 1, further comprising a memory coupled to or incorporated in the controller (20) for storing information about the timing parameter.

7. An electrophoretic display unit (1) as claimed in claim 6, wherein the information comprises row delay parameters, whereby the driving signal comprises a column driving signal and a row driving signal for providing:
shaking pulses (Sh), with a corresponding first row delay parameter defining a first row delay time;
one or more reset pulses (R), with a corresponding second row delay parameter defining a second row delay time; and
one or more driving pulses (Dr), with a corresponding third row delay parameter defining a third row delay time; whereby the first row delay time is a fixed row delay time, with the first row delay time being shorter than the second row delay time, and with the third row delay time being a flexible row delay time.

8. A display device comprising an electrophoretic display unit (1) as claimed in claim 1; and a storage medium for storing information to be displayed.

9. A method for driving an electrophoretic display unit (1) comprising an electrophoretic display panel (DP) comprising lines with pixels (11); the method comprising the steps of:
varying a timing parameter of a line driving signal for varying a frame rate of the electrophoretic display unit (1); and
driving the lines with the line driving signal.

10. A computer program product for driving an electrophoretic display unit (1) and comprising the functions of:
in response to line driving signals, driving lines with pixels (11) of the electrophoretic display unit (1); and
supplying a line driving signal having a timing parameter, which timing parameter is adapted to be varied for varying a frame rate of the electrophoretic display unit (1).

11. A controller (20) for supplying a line driving signal having a timing parameter to a line driver (40) for driving lines with pixels (11) of an electrophoretic display panel (DP) of an electrophoretic display unit (1), the controller (20) being adapted to vary the timing parameter for varying a frame rate of the electrophoretic display unit (1).
